(19) United States
(12) Patent Application Publication
(10) Pub. No.: US 2011/0316793 A1
(43) Pub. Date: Dec. 29, 2011

(54) SYSTEM AND COMPUTER PROGRAM FOR VIRTUAL MUSICAL INSTRUMENTS

(75) Inventor: Ikko Fushiki, Sunnyvale, CA (US)

(73) Assignee: DIGITAR WORLD INC., Stateline, NV (US)

(21) Appl. No.: 12/901,080

(22) Filed: Oct. 8, 2010

Related U.S. Application Data
(60) Provisional application No. 61/359,015, filed on Jun. 28, 2010.

(51) Int. Cl. G06F 3/041; G06F 3/048

(52) U.S. Cl. 345/173; 715/810

(57) ABSTRACT

A system and computer program for virtual musical instruments includes a touch-sensitive screen; a selection interface that presents a list of virtual instruments on the screen for the user to select a virtual instrument; and a performance interface that presents a plurality of virtual instrument input elements on the screen for the user to play the virtual instrument by touching the screen. The system utilizes the location and speed of the user's touches to produce the sound, which may be a note produced with a sound effects library.

### RELATED APPLICATIONS

This application claims the benefit of the filing date of U.S. Patent Application No. 61/359,015, filed Jun. 28, 2010, which is incorporated herein by reference in its entirety.

### BACKGROUND OF THE INVENTION

The present invention generally relates to computer-based music and more specifically to a system and computer program for virtual musical instruments.

It would be desirable if the user does not have to buy harmonicas or other instruments for different keys. It would be desirable to automatically adjust according to the key set up.

Further, it may not be easy to use a real bow to play a virtual violin.

It would be desirable to have a computer system that allows the user to play virtual musical instruments.

### SUMMARY OF THE INVENTION

In one aspect of the present invention, a system includes a first computer interface to select a virtual instrument; and a second computer interface to receive a musical instrument input; wherein the system measures a speed and an acceleration of the musical instrument input, identifies a location of the musical instrument input, and utilizes the speed, acceleration, and location to produce a sound.

In another aspect of the present invention, a system for a user to produce a sound includes a touch-sensitive screen; a selection interface that presents a list of virtual instruments on the screen for the user to select a virtual instrument; and a performance interface that presents a plurality of virtual instrument input elements on the screen for the user to play the virtual instrument by touching the screen; wherein the system utilizes the location and speed of the user's touches to produce the sound.

In yet another aspect of the present invention, a method for producing a sound includes selecting a virtual instrument; displaying a representation of a virtual instrument input element for the selected virtual instrument on a touch-sensitive screen; receiving a touch on the screen; identifying a location, a speed, and an acceleration of the touch; and utilizing the location, speed, and acceleration to produce the sound.

### BRIEF DESCRIPTION OF THE DRAWINGS

FIG. 1 is an exemplary screen shot of an embodiment to select virtual musical instruments according to the present invention;

FIG. 2 is a further exemplary screen shot to select virtual musical instruments according to the embodiment of FIG. 1;

FIG. 3A is an exemplary screen shot for a virtual piano according to the embodiment of FIG. 1;

FIG. 3B is an exemplary screen shot of a virtual piano with video playback according to the embodiment of FIG. 1;

FIG. 4A is an exemplary screen shot of a virtual guitar according to the embodiment of FIG. 1;

FIG. 4B is an exemplary screen shot of a virtual guitar according to the embodiment of FIG. 1 in use;

FIG. 4C is an exemplary screen shot of string-bending for a virtual guitar according to the embodiment of FIG. 1;

FIG. 4D is an exemplary screen shot of a combined virtual piano and virtual guitar according to the embodiment of FIG. 1;

FIG. 5 is an exemplary screen shot of a virtual violin according to the embodiment of FIG. 1;

FIG. 6A is an exemplary screen shot of a virtual wind instrument according to the embodiment of FIG. 1;

FIG. 6B is an exemplary screen shot of a virtual harmonica according to the embodiment of FIG. 1;

FIG. 6C depicts an embodiment of a virtual harmonic according to the embodiment of FIG. 1 in use;

FIG. 7 is an exemplary screen shot of a virtual drum set according to the embodiment of FIG. 1;

FIG. 8A is an exemplary screen shot of a virtual tambourine according to the embodiment of FIG. 1;

FIG. 8B depicts an exemplary screen shot of a virtual tambourine according to the embodiment of FIG. 1 in use;

FIG. 9 is an exemplary screen shot of a setup screen according to the embodiment of FIG. 1; and

FIG. 10 is a flowchart of a system according to the embodiment of FIG. 1.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

Broadly, an embodiment of the present invention generally provides a system and computer program for virtual musical instruments. Embodiments may handle multiple touch inputs at the same time, and may play multiple notes in a music program at the same time in an application.

An embodiment of a music software system may play multiple notes (or sound) at the same time, without any external devices, utilizing touch-screen devices, such as (but not limited to) Apple®, iPad™, iPhone™, iTouch™, or similar touch screen devices. An embodiment of music software may display different instruments including percussion instruments, and may add various sounds and effects. A music software system may keep track of multiple finger inputs at the same time in touch screen devices. The system may record where and when each finger is pressed, released, and dragged. Each finger input and movement may be interpreted according to each instrument setup. Other body parts such as lips, tongue, chin, etc., or possibly any other body part, may be used as inputs.

Embodiments may include features or modules for a user interface (UI), an input, speed and/or acceleration measurement, conversion to notes and sound, a sound and effect library, and an output. Other embodiments may include recording and playback, import and export, and digital music instruments for other software. Embodiments may have portability when implemented as software on portable devices.

A user interface (UI) may include a main window to describe the list of instruments with instrument icons such as guitar, piano, accordion, flute, drums, tambourine, etc. For each instrument, there may be further options or selections. In the case of a guitar, there may be selections (list or icons) such as electric guitar, acoustic guitar, classic guitar, etc. Icons or pictures of instrument may appear in the screen so that a particular instrument may be selected, and then the selected instrument is displayed.

An input may utilize finger touches, which may be interpreted as notes or bending of strings according to each instrument. A virtual instrument input element, such as a string, key, or surface, may be displayed to indicate where the user should touch the input. Multiple finger touches may be interpreted at the same time. This enables music software to play the chords or notes of the music. Other body parts such as lips, tang, chin, etc can be used as inputs.

An embodiment may include features for speed or acceleration or both. When a device has an accelerometer or a gyroscope, the push of the finger may change the acceleration or the direction. By measuring the change of magnitude and direction of the acceleration along with the location of the touches, an embodiment may interpret the change as the strength of the finger touch. The system may change the volume of the note according to the acceleration changes. In case of a percussion device, this may be interpreted as the strength and direction of hitting the percussion device. Embodiments of the touch screen may be velocity sensitive, and the velocity can be used to interpret finger touches and movement.

An embodiment may convert input to notes and sound. The finger or other body part inputs along with location, speed, and acceleration may be interpreted as a note, its volume, and its pitch, which may change according to each instrument. In an embodiment, multiple devices with different implementations or play methods may be played at the same time. The input may not be limited to the fingers. Parts of the body such as lips or other body parts may be used as inputs to the system.

Embodiments may include a sound library or an effect library or both. Each instrument may be assigned a sound or timbre that is used to produce notes. For example, a piano may select different notes for each key. In case of a guitar, each string may have a different note. Software controlled sound effects could be added utilizing an algorithm. Such effects, such as chorus, distortion, feedback, and a wow-wow pedal, may be applied in each sound. Sounds and effects could be added as plug-ins.

Embodiments may include an output. Inputs from a user's finger or other body part may be converted to sound signals (wave data) and send to an operating system's sound manager.

Embodiments may include recording and playback. User's inputs may be recorded in a proprietary format and used for playback along with the display, as if the instrument is being played in live.

Embodiments may have features for import and export. Sheet music may be converted to a suitable format internally and played. The user's input may be exported as a sheet music, although it may lose the delicate instrumental details.

Embodiments may include digital music instruments for other software. With the cooperation of additional software, the system's music software may be the input device of the additional software. For an example, a virtual instrument may become the guitar of Guitar Hero™, or another vender could write software for the system's music instruments.

Embodiments may provide portability. There is no extra device needed to use embodiments of the music instrument software. Travelers may use their touch screen device to play the software in airports, hotels, restaurants, etc. If there are other users, they may play together.

An embodiment of a user interface (UI) may allow the user to choose his instrument with a selection interface. When the instrument is selected, the UI may display the virtual musical instrument in a performance interface. The user may regard the display as the real instrument and can push the instrument's virtual keys just like the real ones. If the user knows how to play the real instrument, the user may play a virtual instrument in a similar way utilizing the input. An accelerometer or gyroscope may be used to get more information regarding speed and acceleration. This may give information of the strength of the user's touch, which may be important in music. The information, including input and speed and acceleration, may be interpreted in the music software to convert to notes and pitch changes. The user may select different sounds and effects through the sound and effect library to have interesting music. Converted notes and sounds may be digitized to a form of sound waves before the result is output and sent to the sound manager of an operating system.

In embodiments, the user inputs, speed and acceleration, and note and sound data may be saved or recorded in an appropriate format for each instrument. This saved file can be played back as if the user is playing live. Other music formats may be imported and exported with file format conversion. By using appropriate import and export, it may be possible to use the music instrument software for other software or vice versa. The portable device may be used by people to enjoy the music software without bringing extra devices. Users may play the virtual instruments together.

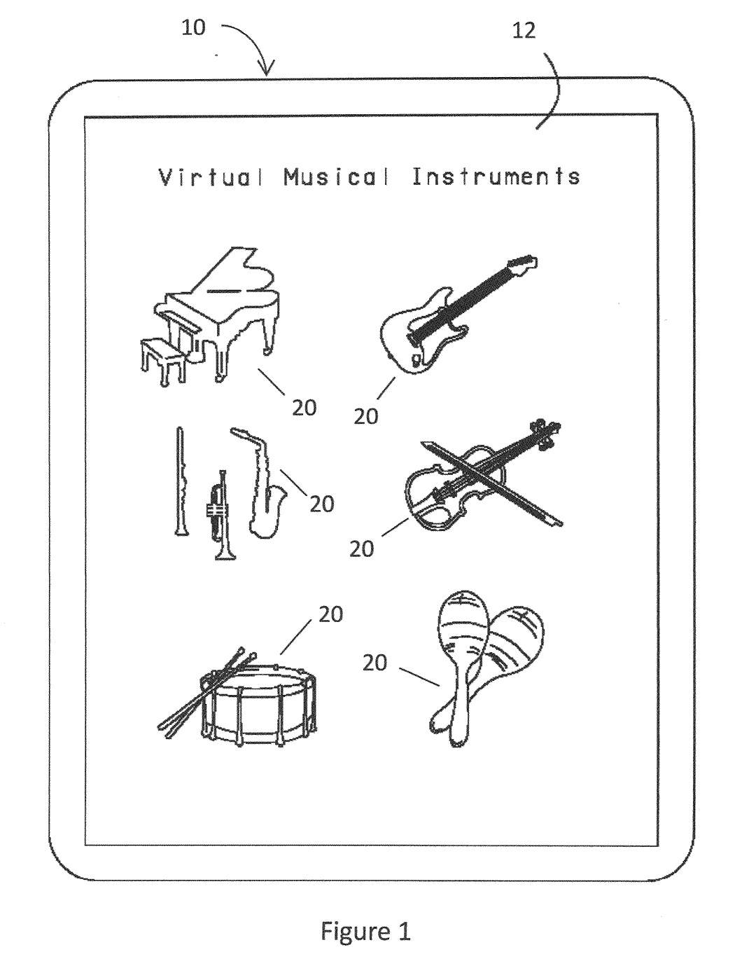

As depicted in FIG. 1, an embodiment of a system 10 may have a graphical user interface to present a touch-sensitive screen 12 that allows the user to select various virtual musical instruments. Icons 20 may indicate areas for the user to touch, to select virtual instruments such as piano, guitar, violin, wind instruments, drum sets or percussion instruments.

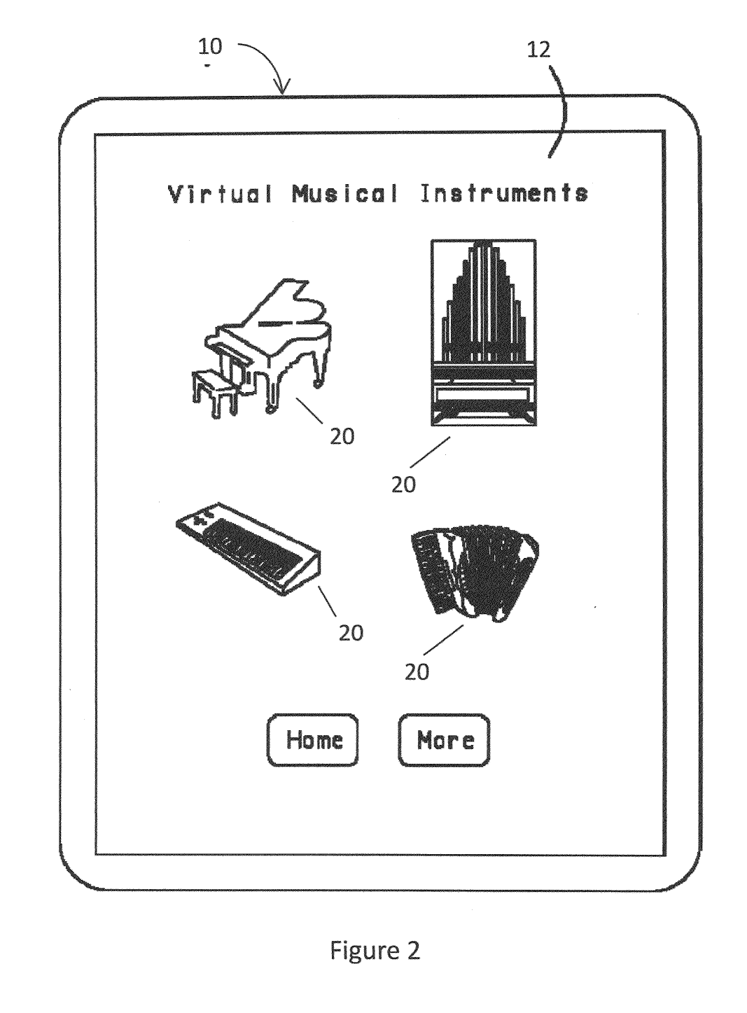

As depicted in the embodiment of FIG. 2, a system 10 may have additional icons 20 for various virtual instruments.

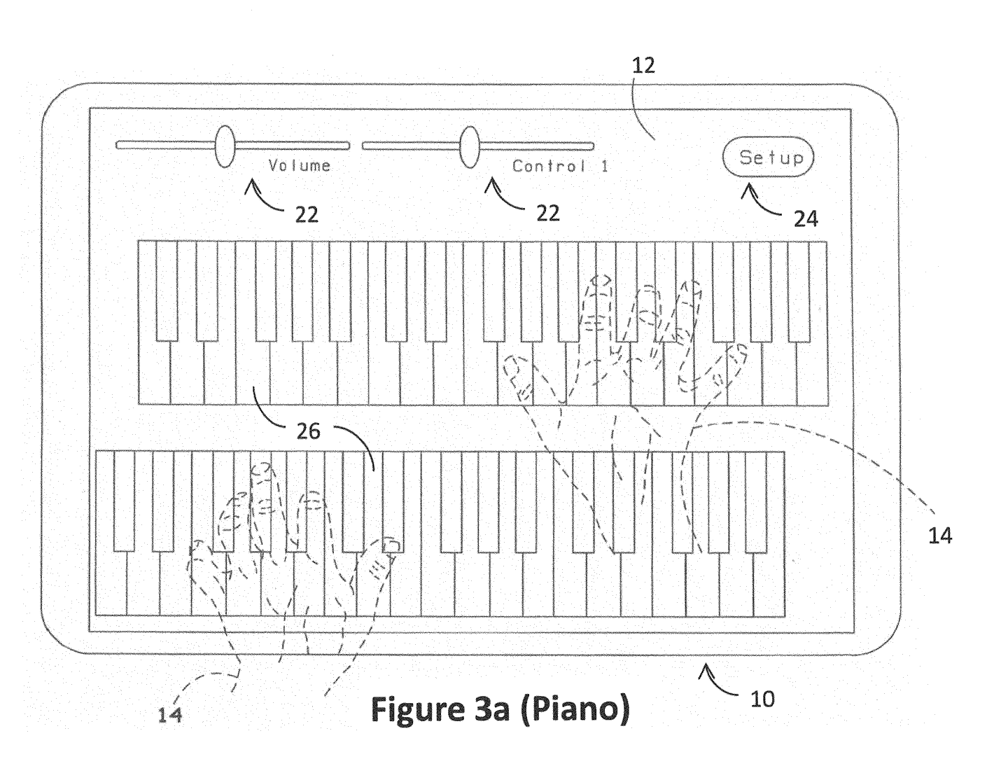

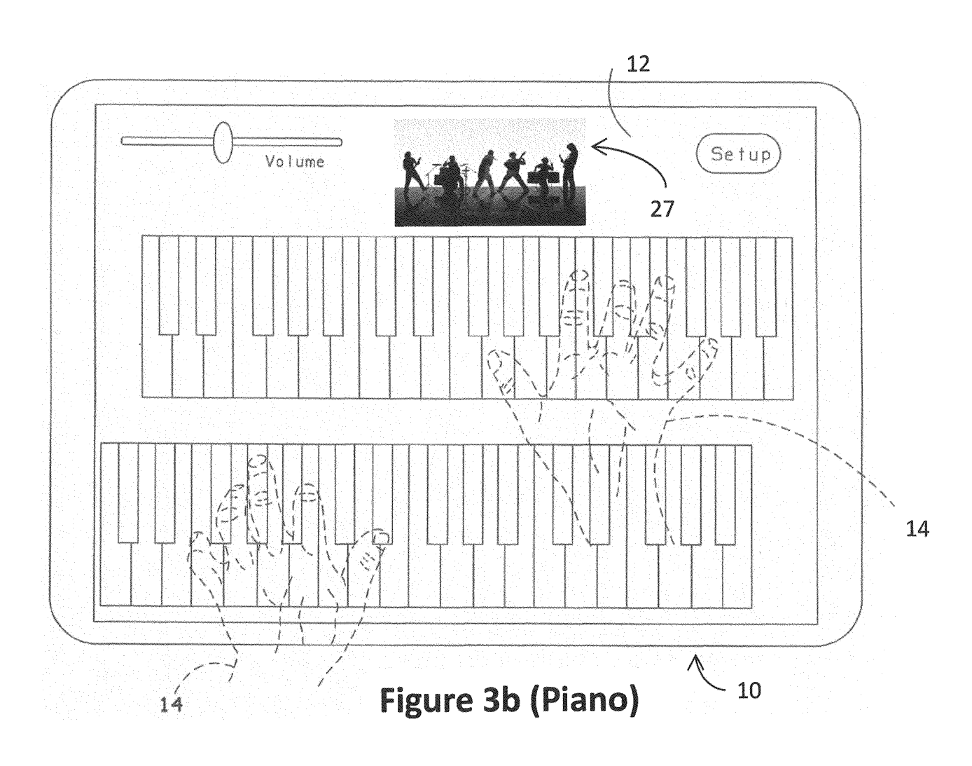

As depicted in FIG. 3A, an example of a touch-screen 12 for a piano may have an input area 26 that appears to be a virtual keyboard, which may be accessed with the user's hands 14. The top part of the input area 26 may be a top for the right hand, and the bottom part may be for the left hand. The touch-screen 12 may have additional input areas such as sliders 22 for volume, control, or a setup button 24.

As depicted in FIG. 3B, an example of a virtual piano screen may include a control used as video playback or music playback for play along-reverse Karaoke. The screen 12 may include an area for video play back 27. A user may select a video or music from a collection in the user's mobile device. The user may play a virtual instrument along with the video or music. In Karaoke, a person adds a singing part. In this play-along feature, the user may add the instrument parts. This is a reverse Karaoke in that sense.

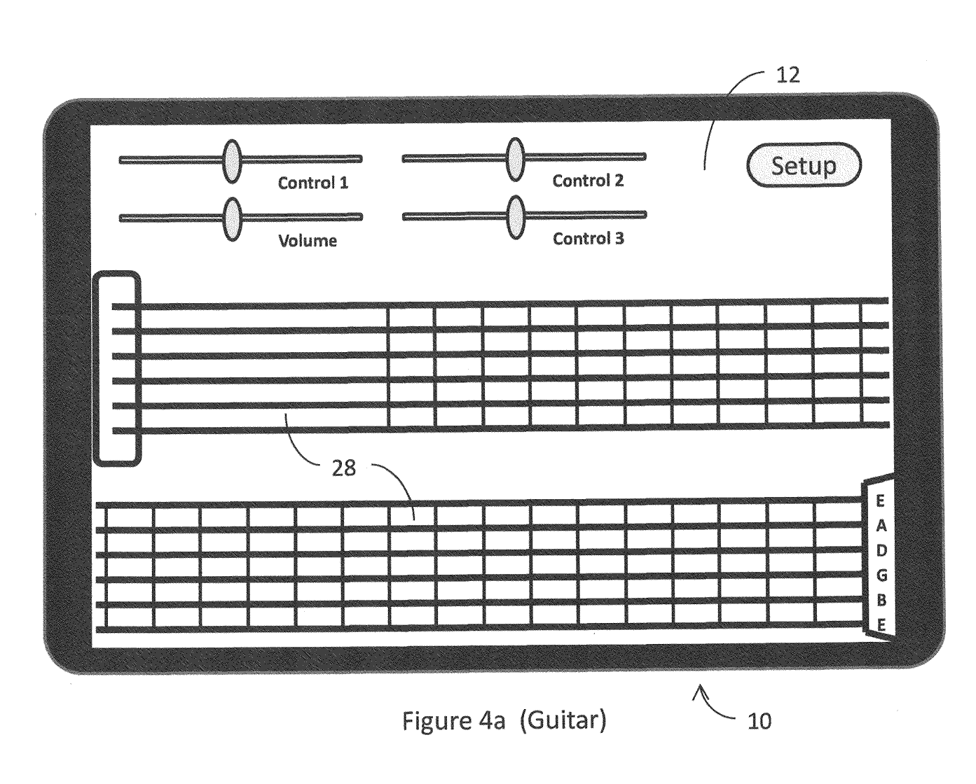

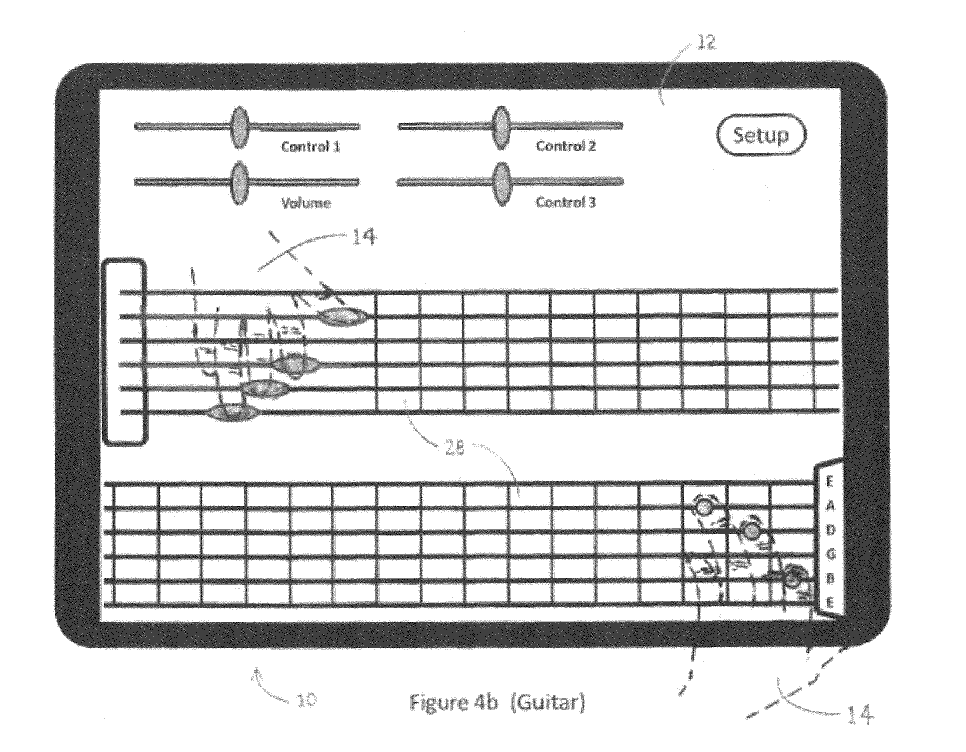

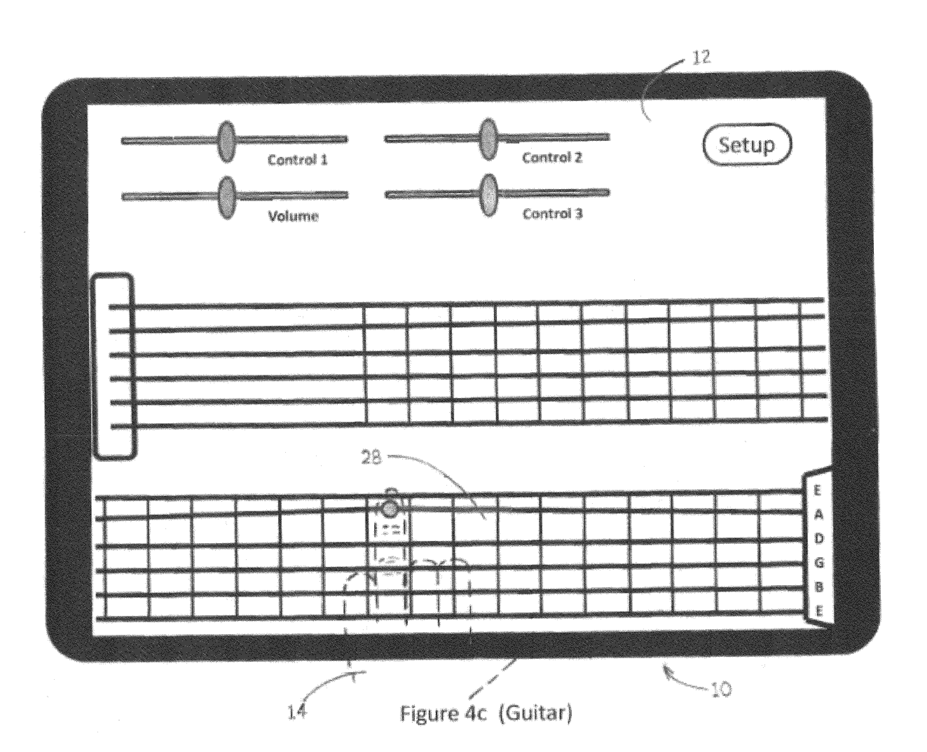

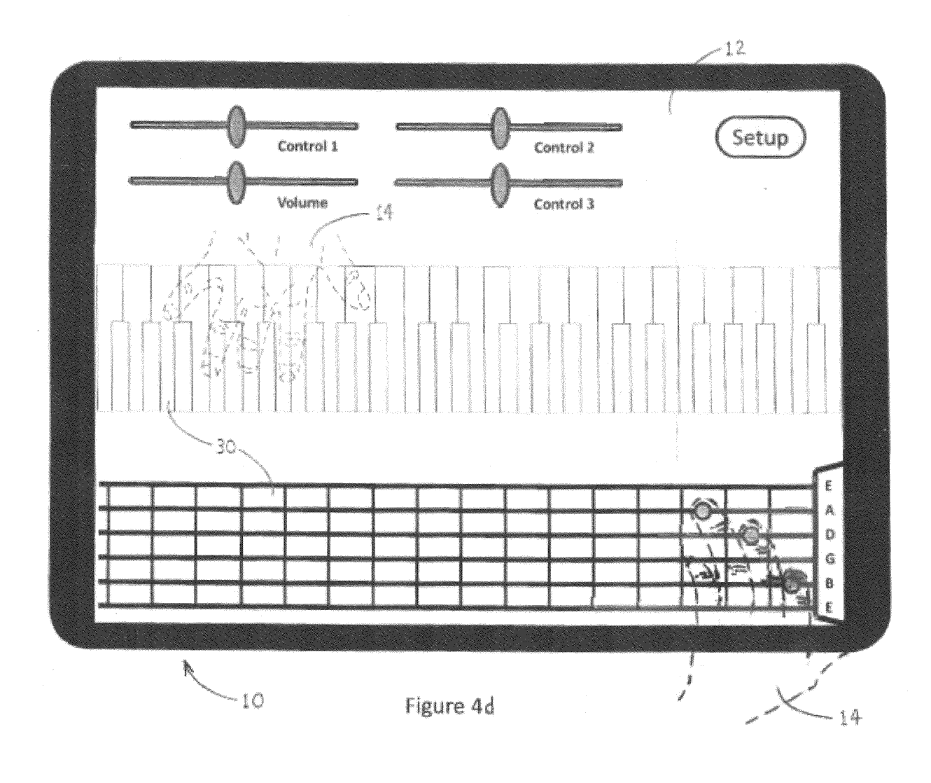

FIG. 4A depicts an example of a touch-screen 12 for a guitar having an input area 28 that appears to be virtual guitar strings. As depicted in the embodiment of FIG. 4B, the input area 28 may be accessed with the user's hands 14. The top part of the input area 28 may be for the right hand, which is usually a place to pick strings, and the bottom part may be for the left hand, which is usually used to press the notes in the guitar strings.

FIG. 4C depicts an embodiment of a system utilizing string-bending for a guitar, where the user presses up upon a virtual string in the input area 28. This technique is often used in real guitars.

FIG. 4D depicts an example of using two different instruments at the same time. The guitar part is played with the user's left hand, and the piano is played with the user's right hand. In such an example, the user may add a keyboard and guitar to his or her mobile device. The user may use his/her left hand for the guitar and his/her right hand for the piano. The guitar may be set to a tapping method so that the pressed keys are played.

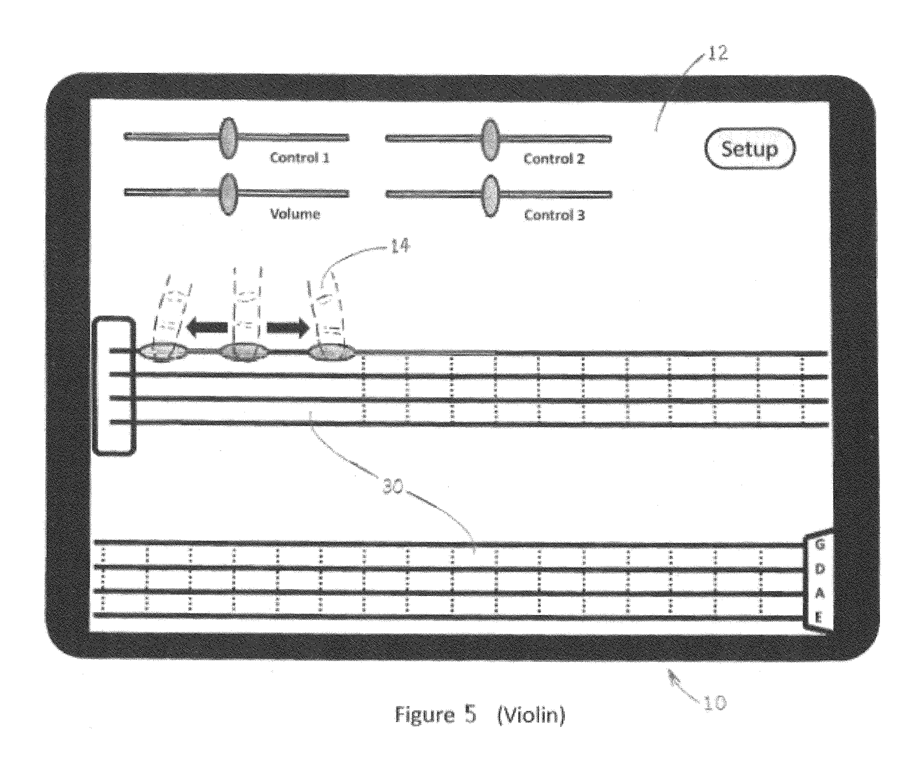

FIG. 5 depicts an embodiment of a touch-screen for a guitar having an input area 30 that appears to be virtual violin strings. In the embodiment of FIG. 5, a finger movement along a virtual string in the input area 30 may be used to play a particular string. To play multiple strings, one may stroke multiple strings along their common direction. This violin technique may be used for guitar as well.

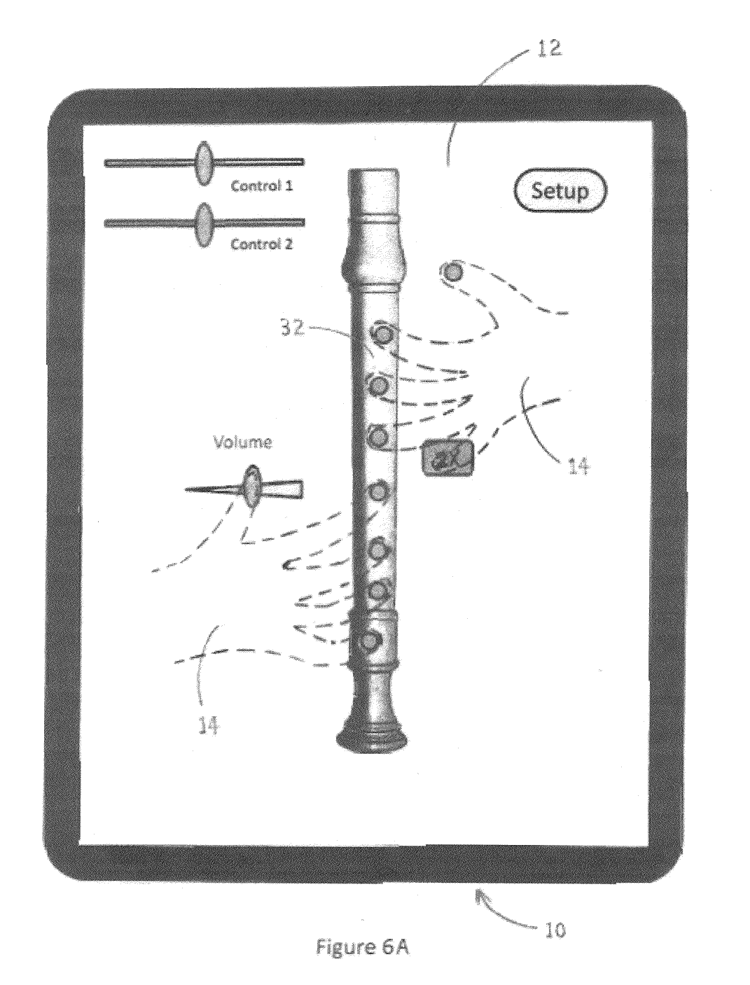

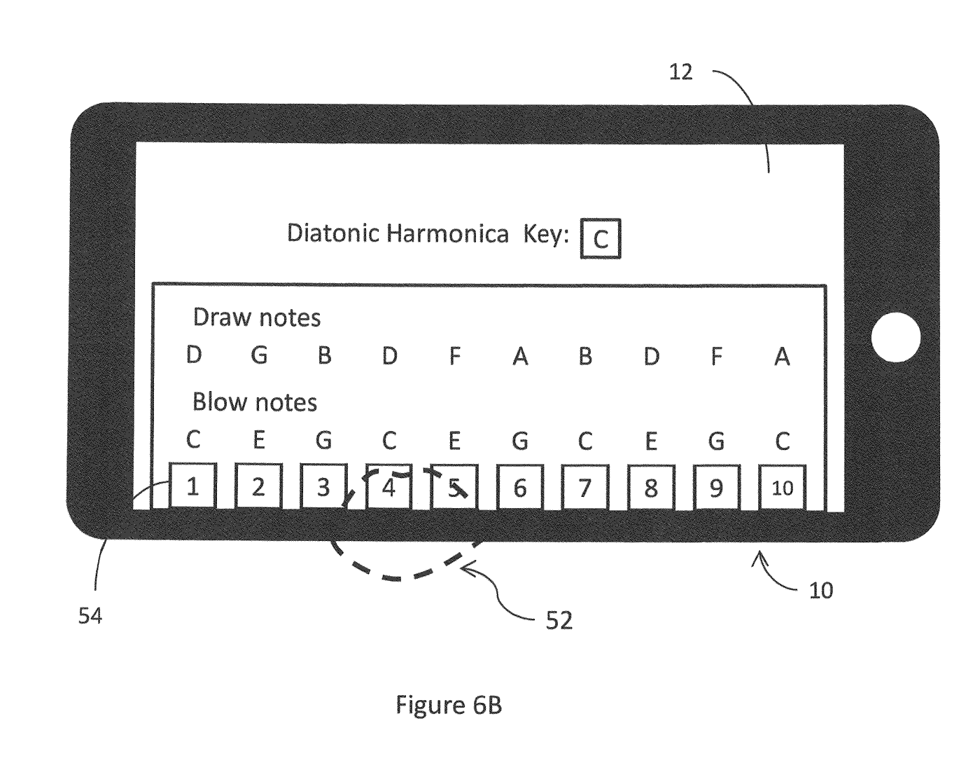

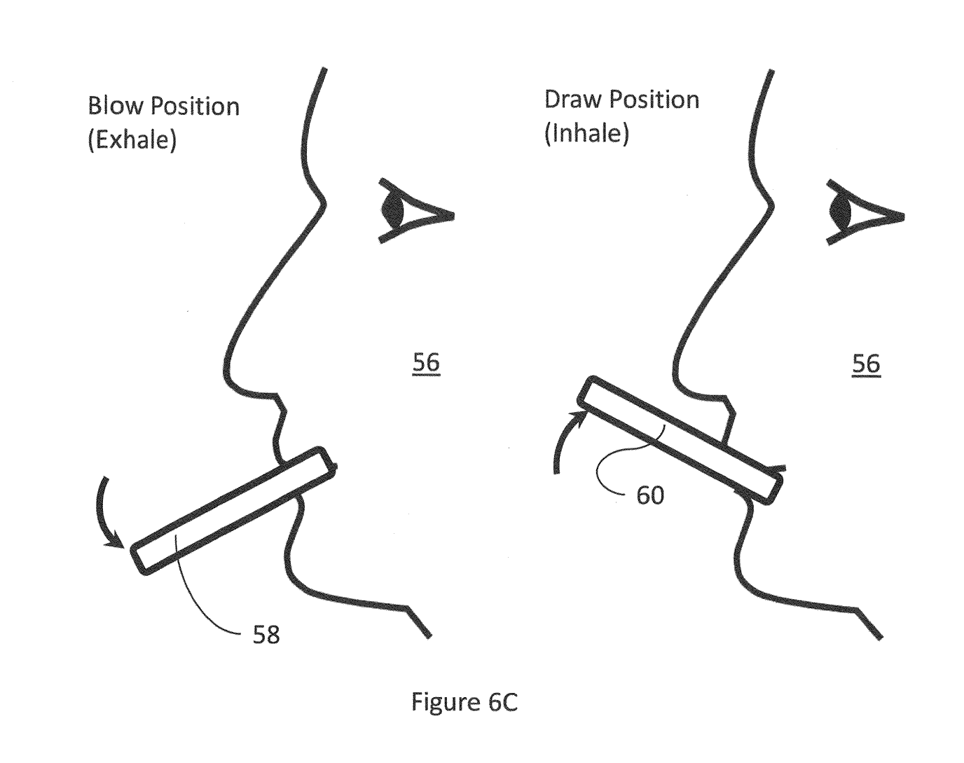

FIG. 6A depicts an embodiment of a touch-screen for a wind instrument having an input area 32 that appears to be virtual keys or holes on a wind instrument. The user's hands may be used to play a virtual recorder. A “2×” button may be included to play an octave higher note. The right thumb may be used to adjust the volume. Other instruments may include, but are not limited to, a clarinet, trumpet, or saxophone.

FIG. 6B depicts an embodiment of a touch screen for a harmonica. The user's mouth or lips 52 or both may be used to select the notes from an input area 54 for a harmonica. The user may select a diatonic harmonica of the key of C to his/her mobile device. In a real diatonic harmonica, the user might play different notes depending on whether he/she blows (exhales) or draws (inhales) utilizing the keyholes. The draw notes and blow notes of the diatonic harmonica with a specific key may be drawn into or out of the mobile device. If the user selects different keys in a mobile device interface, other notes may be displayed. The user may touch the notes, which are numbered from 1 to 10, by his/her lips just as he/she might play a real harmonica. Also the user may use his/her finger to select notes utilizing another interface such as the hand, as well in addition to utilizing his/her lips to provide an input.

FIG. 6C depicts an embodiment of a user 56 controlling sound using his lips and mouth. Lowering and lifting the touch screen device may control the volume, just as if the user were to blow or draw the notes from a real harmonica. The user may exhale in a blow position 58, or may inhale in a draw position 60. Instead of blowing (exhaling) or drawing (inhaling) a harmonica, the user changes the angle of the harmonica. This is the side view of the mobile device. When the mobile device is lowered as “Blow Position”, the Blow notes in the previous figure may be played. When the mobile device is lifted as “Draw Position”, the Draw notes in the previous figure may be played. The sound volume can be controlled by the angle of lowing and lifting. The user may use his/her hands to lower or lift the harmonica (hands are omitted in FIG. 6C to clarify the movement of the harmonica).

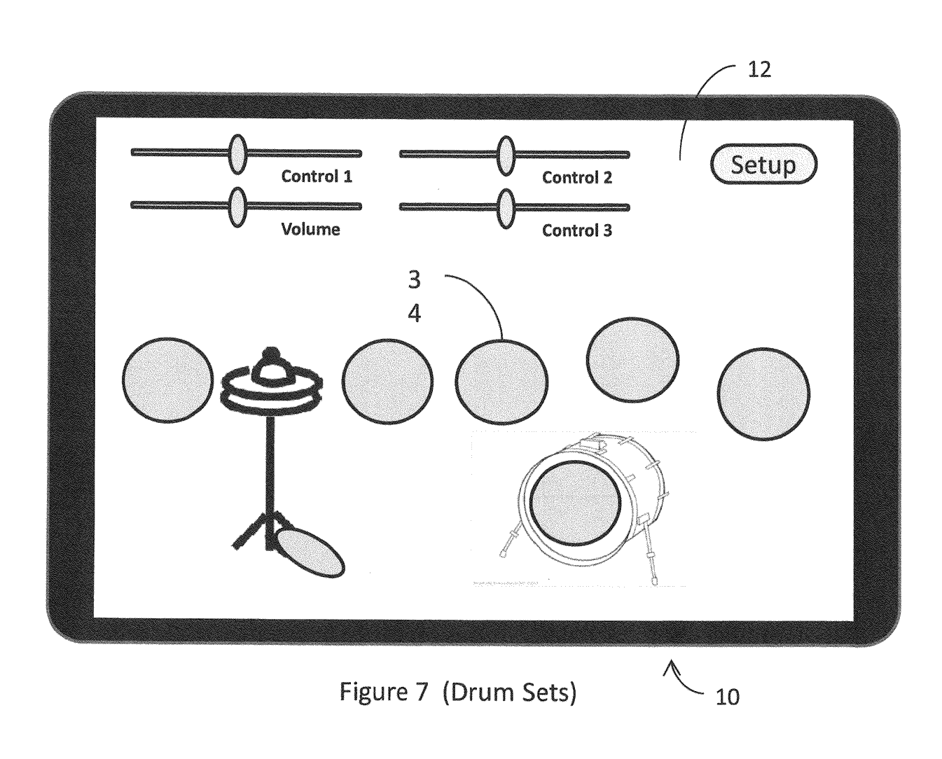

FIG. 7 depicts an embodiment of a touch-screen for a drum set having an input area 34 that appears to be the surfaces of percussive instruments. A user may hit gray circles and ovals to make sounds. He can use fingers of both hands including the thumbs to play the drum set, or he can use just two index fingers to play the drum set.

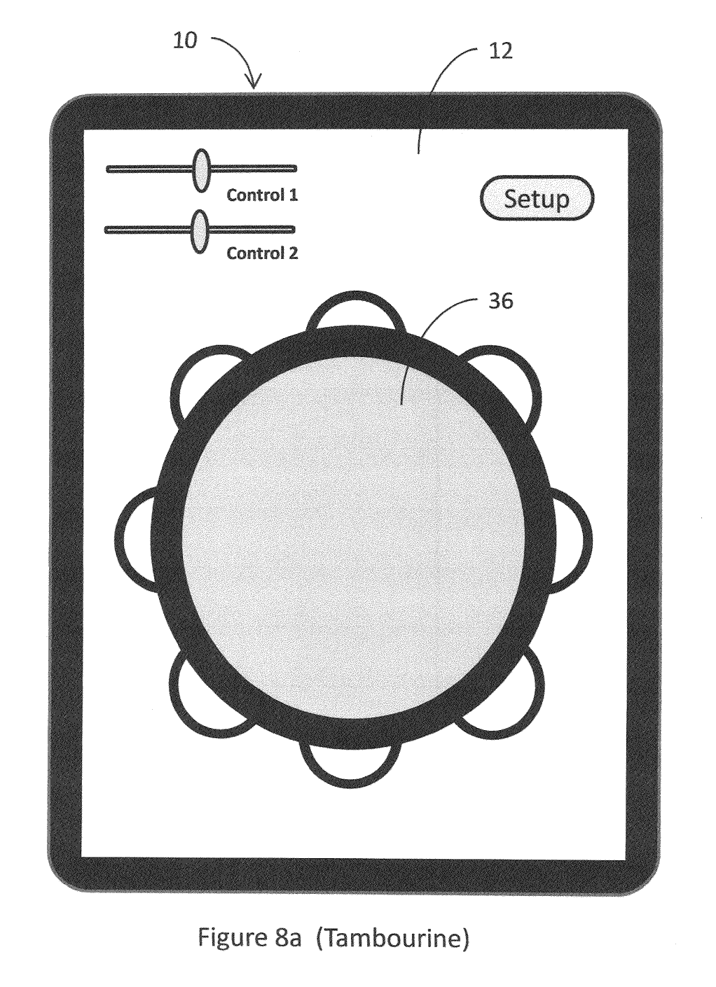

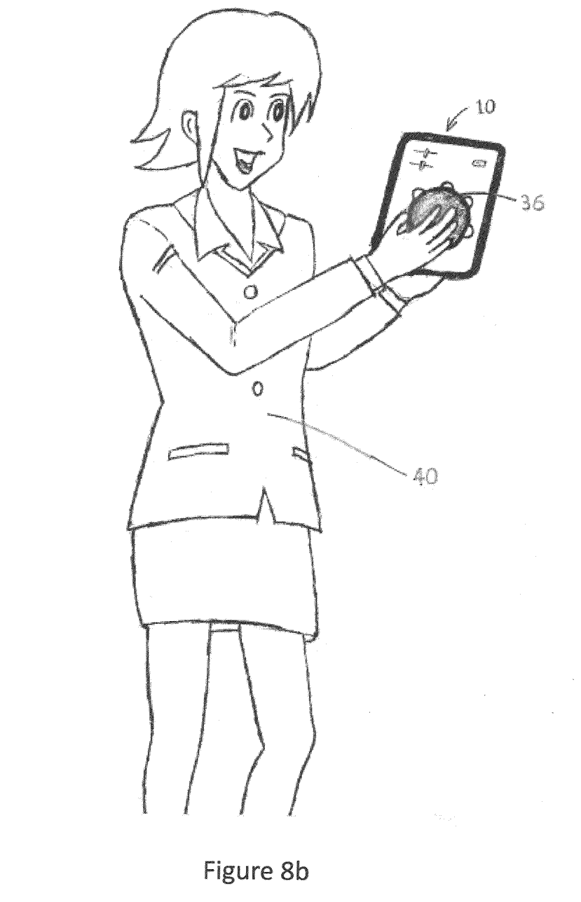

FIG. 8A depicts an embodiment of a touch-screen for a tambourine having an input area 36 that appears to be a tambourine. FIG. 8B shows how one may play an embodiment of a virtual tambourine. A user 40 is holding the device 10 in her left hand. She is shaking and hitting the input area 36 of the device 10, to create a sound just like a real tambourine.

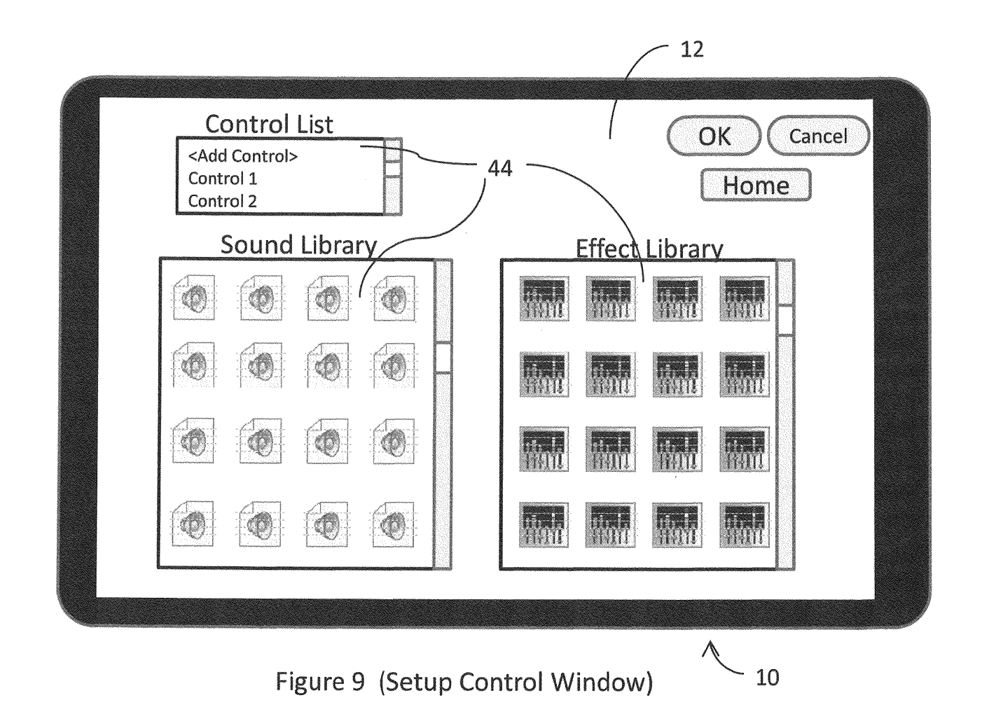

FIG. 9 depicts an embodiment of a setup control window. The screen 12 may have input areas 44 for a control list, a sound library, and an effect library.

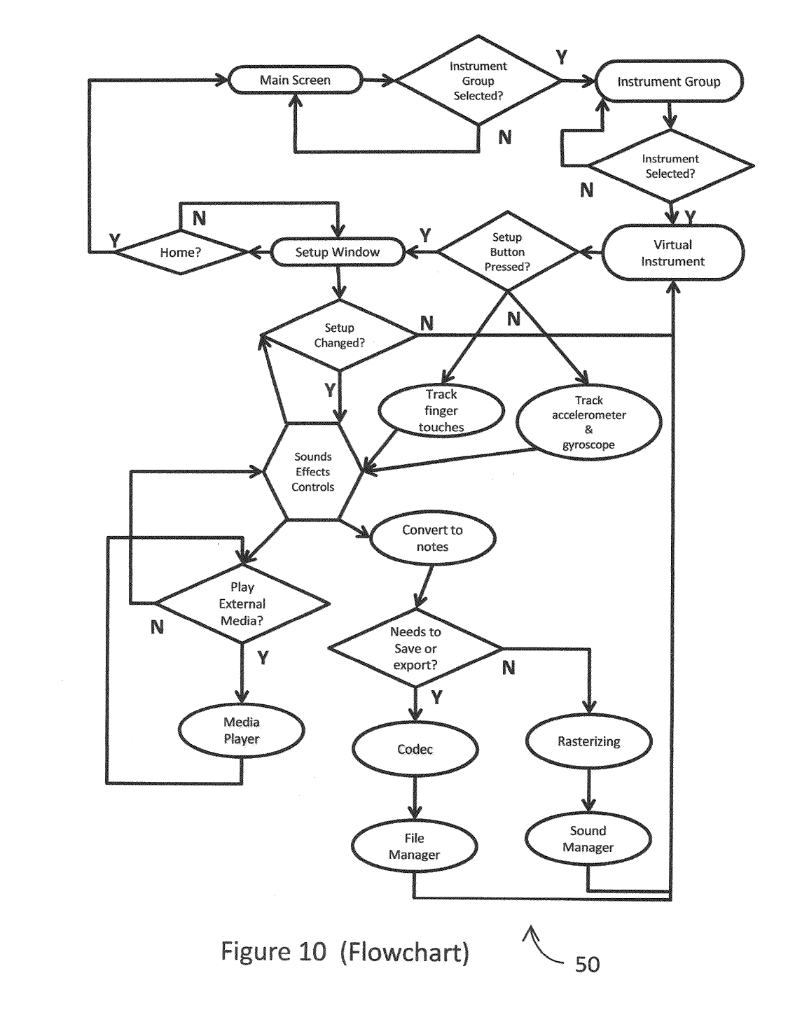

FIG. 10 depicts a flowchart of an embodiment of a computer program 50 according to the present invention. The process starts with the main screen, and may include selecting a virtual instrument, tracking fingers touches and the accelerometer, utilizing sounds effects controls, and converting to notes.

Embodiments may include intuitive, usable software. A user that knows how to play a real guitar, piano, accordion, etc., may play without any instruction since the virtual instruments may work just like the real ones. Percussion devices may be hit or shaken so that the virtual percussion devices produce sounds. In case of a tambourine, the user can shake and hit the virtual device to produce sounds just like the real ones.

Embodiments may handle multiple inputs and movements at the same time. Embodiments of software components may be used as a controlling device for other devices. The user may manipulate something using multiple fingers or other body parts such as lips, tang, chin, etc. One example is a control device of a doctor's computer surgery, where the doctor might operate the survival device remotely with the software. Embodiments may be used with other software utilizing multiple finger inputs, for example, software that appears as if we are manipulating Play-Doh® or other clay with multiple fingers. Other example is a software for physically handicapped. The user may use his or her lips or tang to control the touch sensitive device.

Embodiments may be implemented in a device with a multi-touch sensitive operating system.

Embodiments may include a computer program for a portable touch-sensitive device including a user interface module to select a virtual instrument, an input module to receive input from the touch-sensitive device, a speed acceleration module to identify the speed and acceleration of the input, a gyroscope to identify the directional changes, a sound and effect library to provide sounds for the virtual instrument, a conversion module to convert the input to notes and sound, and an output module to output the notes and sound.

Embodiments may include combined instruments or universal musical instruments. For example, one can play a virtual guitar and piano at the same time by displaying one keyboard and one set of guitar strings.

Embodiments may include an option to magnify the play area. When a user touches a certain area, that area is magnified or zoomed in for ease of play.

Embodiments may allow volume control by catching or tracking the velocity of finger movement. For example, certain products such as iPad® may not be velocity sensitive. When a user slides a finger in the same key area, an embodiment may regard it as the volume control. The faster the finger moves, the louder, the sound will become.

I claim:

1. A system, comprising:
a first computer interface to select a virtual instrument; and
a second computer interface to receive a musical instrument input;
wherein the system measures a speed and an acceleration of the musical instrument input, identifies a location of the musical instrument input, and utilizes the speed, acceleration, and location to produce a sound.

2. The system of claim 1, further comprising:
a touch-sensitive screen that presents the first computer interface to a user, receives a selection from the user, and then presents the second computer interface to the user.

3. The system of claim 2, wherein the touch-sensitive screen is velocity sensitive.

4. The system of claim 1, further comprising:
an accelerometer to measure an acceleration of the musical instrument input.

5. The system of claim 1, further comprising:
a gyroscope to measure the directional changes of the musical instrument.

6. The system of claim 1, further comprising:
a software module to identify the speed and acceleration of the musical instrument input by tracking a user's finger movement.

7. The system of claim 1, further comprising:
a sound effects library, wherein the musical instrument input relates to a note, the system forms the note utilizing the sound effects library, and the sound includes the note.

8. The system of claim 1, wherein:
the system utilizes the speed and location to interpret a volume and a pitch of a note for the selected virtual instrument.

9. The system of claim 1, wherein:
the musical instrument input is provided by a plurality of fingers of a user, and the fingers press upon the second computer interface to identify a plurality of sounds at the same time.

10. The system of claim 1, wherein:
the musical instrument input is provided by a plurality of body parts of a user, and the body parts press upon the second computer interface to identify a plurality of sounds at the same time.

11. The system of claim 1, wherein the second computer interface displays a virtual instrument input element that indicates an area for the user to touch the interface.

12. The system of claim 1, wherein the second computer interface displays a virtual string and the user touches and moves the string to indicate bending of a note.

13. The system of claim 1, wherein the system records the sound and plays back the recorded sound.

14. A system for a user to produce a sound, comprising:
a touch-sensitive screen;
a selection interface that presents a list of virtual instruments on the screen for the user to select a virtual instrument; and
a performance interface that presents a plurality of virtual instrument input elements on the screen for the user to play the virtual instrument by touching the screen;
wherein the system utilizes the location and speed of the user's touches to produce the sound.

15. The system of claim 14, wherein the virtual instrument input elements are representation of strings, and the user touches the screen with a finger and moves the finger along the screen to indicate bending of a note of a virtual string instrument.

16. The system of claim 14, further comprising:
a software module that tracks the location and movement of the user's touches to calculate the speed.

17. A method for producing a sound, comprising:
selecting a virtual instrument;
displaying a representation of a virtual instrument input element for the selected virtual instrument on a touch-sensitive screen;
receiving a touch on the screen;
identifying a location, a speed, and an acceleration of the touch; and
utilizing the location, speed, and acceleration to produce the sound.

18. The method of claim 17, further comprising:
utilizing a sound effects library that includes the selected virtual instrument together with the location and speed of the touch to produce the sound.

19. The method of claim 17, wherein the virtual instrument input element is a representation on the screen of a string, and the user touches the representation with a finger and moves the finger along the screen to indicate bending of a note or stroking of a bow.

20. The method of claim 17, wherein the virtual input element is a representation including air exhale and inhale, the user touches the representation with lips, and the user tilts the device to indicate the exhaling and inhaling of the notes in the device.
